(19) United States
(12) Patent Application Publication
(10) Pub. No.: US 2019/0146648 A1
(43) Pub. Date: May 16, 2019

(54) COLLABORATIVE SYSTEM AND METHOD WITH DRAG ALONG BROWSING AND READING POSITION APPROXIMATION ON A DISPLAY DEVICE

(71) Applicant: Breezio Inc., Rockville, MD (US)

(72) Inventors: Siavash Mahmoudian-Bidgoly, Potomac, MD (US); Kamyar Kaviani, Potomac, MD (US)

(73) Assignee: Breezio Inc., Rockville, MD (US)

(21) Appl. No.: 16/243,772

(22) Filed: Jan. 9, 2019

Related U.S. Application Data
(63) Continuation of application No. 14/723,262, filed on May 27, 2015.
(60) Provisional application No. 62/003,510, filed on May 27, 2014.

(51) Int. Cl. G06F 3/0484; G06F 16/954; G06F 3/01; G06F 3/0481; H04L 12/18; G06Q 10/10; G09B 5/08; G06F 3/14; G06Q 50/00

(52) U.S. Cl. CPC G06F 3/0484; G06F 16/954; G06F 3/011; G06F 3/04812; H04L 12/1822; G06Q 10/101; G09G 2370/022; G06F 3/1454; G06Q 50/01; G09G 2340/14; G09G 2340/145; G09G 2354/00; G09B 5/08

(57) ABSTRACT

A collaboration system comprises one or more servers configured to interface with a plurality of user devices over a network. The plurality of user devices comprises a first user device and one or more second user devices that are different user devices. A receiver node is configured to receive a reading position information. The reading position information corresponds to a pointer position within a window on a display of the first user device. A processor node is configured to determine a second device of the one or more second user devices to receive a display message relating to the reading position information.

### FIELD OF THE INVENTION

The present invention relates generally to a system and method for collaboration among participants in an online environment. More particularly, the present invention relates to a system and method for collaborative browsing content.

### BACKGROUND OF THE INVENTION

With developments in the education industry, students and professionals seek access to courses, training materials, and other content to improve their skills and knowledge anywhere, anytime. Students want current, relevant, interesting and engaging course materials and assignments taught by teachers, instructors, counselors and advisors who are aware of student's educational and professional path and goals based on a clear map of course progress and degree program. Enabling and facilitating students' online activities around their campus is a major consideration in providing the desired student experience. In today's competitive working landscape, businesses and professionals want to acquire and improve upon their skills and knowledge and to be equipped with the most up-to-date technical and professional skills in order to become more effective on the job as well as gain a professional edge.

Educational services are increasingly offered over global networks of institutions, universities, businesses, and companies through Learning Management Systems (LMS), otherwise known as E-learning systems. E-learning systems implement educational platforms using software to deliver, track, and manage learning and teaching to its users. E-learning includes delivery of various types of media such as text, audio, images, and video as well as offering features for online collaboration through technology platforms accessible via a plethora of electronic devices such as desktops, laptops, tablets, and smartphones. E-learning has become the faster, cheaper, and more efficient alternative to traditional learning, which allows for users to have access to the latest information and most updated technology at any time, which is radically changing how we educate and train ourselves and others.

The advent of social networking platforms, collaboration tools, and online meetings, has impacted the way(s) in which E-learners engage with technology in general. E-learning platforms now provide learning environments, which encourage the development of transferable, technical, and social skills through a variety of ways including user-generated content. Responding to the popularity of social networking services among many students, teachers are increasingly using social networks to supplement teaching as they can provide new opportunities for enriching learning through creative, authentic and/or flexible, non-linear learning experiences. Some social networks, such as English, baby! and LiveMocha, are explicitly education-focused and couple instructional content with an educational peer environment. The Web 2.0 technologies built into most social networking services promote conferencing, interaction, creation, research on a global scale, enabling educators to share, remix, and repurpose curriculum resources. In short, social networking services can become research networks as well as learning network.

Social networking services foster learning through what is described as a “Participatory Culture.” A participatory culture consists of a space that allows engagement, sharing, mentoring, and an opportunity for social interaction. Participants of social network services may avail themselves of this opportunity. Informal learning, in the forms of participatory and social learning online, is an excellent tool for users to collaborate in learning. Social networks focused on supporting relationships between teachers and their students are now used for learning, educator professional development, and content sharing. Ning for teachers, TermWiki, Learn Central, TeachStreet and other sites are being built to foster relationships that include educational blogs, eportfolios, formal and ad hoc communities, as well as communication such as chats, discussion threads, and synchronous forums. These sites also have content sharing and rating features.

Companies have begun to merge business technologies and solutions, such as cloud computing, with social networking and collaboration concepts. Instead of connecting individuals based on social interest, companies are developing interactive communities that connect individuals based on shared business needs or experiences. Many provide specialized networking tools and applications that can be accessed via their websites, such as LinkedIn. Others companies, such as Monster.com, have been steadily developing a more “socialized” feel to their career center sites to harness some of the power of social networking sites. These more business related sites have their own nomenclature for the most part but the most common naming conventions are “Vocational Networking Sites” or “Vocational Media Networks”, with the former more closely tied to individual networking relationships based on social networking principles.

With advances in content and media delivery technologies, as well as collaborative tools, there is a need for an E-learning system, which provides a more efficient learning environment integrating instructor-led training with real-time collaboration tools. There is a further need to provide a more intelligent real-time interaction tool.

### SUMMARY OF THE INVENTION

Briefly, according to one aspect of the present invention, a collaboration system comprises one or more servers configured to interface with a plurality of user devices over a network. The plurality of user devices comprises a first user device and one or more second user devices that are different user devices. A receiver node is configured to receive a reading position information. The reading position information corresponds to a pointer position within a window on a display of the first user device. A processor node is configured to determine a second device of the one or more second user devices to receive a display message relating to the reading position information. A transmitter node is configured to transmit the display message to the one or more second user devices.

According to some of the more detailed features of this aspect, the reading position information can be based on a current pointer location and/or a pointer movement pattern. The reading position information can also be based on size of the window, number of paragraphs within the window or size of a paragraph within the window. Moreover, the reading position information can be based on at least one of a position of scrollbar, scrolling speed, scroll direction, or a scrolling pattern. The scrolling pattern can be based on a scrolling history. The reading position information can be based on at least one of a pointer movement on words in a line. The reading position information can based on approximation of a likely viewing position on the display. The reading position information can be derived from zooming the window.

According to some of the more detailed features of this aspect, the transmitter node is configured to broadcast the display message to a plurality of second user devices. Alternatively, the processor node can be configured to check a privilege before transmitting said display message to a second user device. The processor node can be configured to determine a display configuration for a second user device and the transmitter node is configured to transmit the display configuration to the second user device.

According to other the more detailed features of this aspect, the receiver node is configured to receive a viewing position on a first display of the first user device. The viewing position is based on a pointed position within a window on the first display. The processor node is configured to determine at least one of the one or more second user devices to receive a display command to follow the viewing position. The transmitter node is configured to transmit said display command to a second user device.

According to another aspect of the invention the receiver node is configured to receive a media mark (audio, video, image) information from a media play in the first user device. The media mark information comprising a reference in to a media at the first user device. Such reference can be a time reference in an audio or video media and an image reference an image media. Under this aspect, the processor node is configured to check user privileges for determining a second user device to receive a media message relating to the reference in a media at the first user device. The transmitter node is configured to transmit said media message to one or more second user devices. The media mark information can relate to a media pause.

According to still another aspect of the invention, the receiver node is configured to receive a viewing position on a first display of a first user device. The viewing position is based on a pointed position within a window on the first display. Under this aspect, the processor node is configured to determine second user devices to receive a display command to follow the viewing position. The transmitter node is configured to transmit said display command to a second user device.

### BRIEF DESCRIPTION OF DRAWINGS

FIG. 1 shows a block diagram of a collaboration system implementing the present invention on a Software-as-a-Service (SaaS) platform.

FIG. 2 shows the collaboration system implemented as a collaboration service subscribed by a plurality of service providers.

FIG. 3 shows an exemplary block diagram of an online content development system according to one embodiment of the invention.

FIG. 4 shows an exemplary block diagram of a content management center.

FIG. 5 shows an exemplary block diagram of the operation layers of the collaborative online content development system.

FIG. 6 depicts an exemplary server used in the collaboration system.

FIG. 7 is a functional block diagram of a system that incorporates social networking into the system of FIG. 1.

FIG. 8 is a functional block diagram of s server in the system of FIG. 7.

FIG. 9 shows an example of a tutorial displayed on a user interface.

FIG. 10 shows a user chatting with an expert.

FIG. 11 shows drag-along browsing according to one embodiment of the present invention.

FIG. 12 shows paragraph coloring based on users' votes. It helps the author and contributors to find which paragraphs needs to get improved.

FIG. 13 shows a platform path builder.

FIG. 14 shows a video post.

FIG. 15 shows a video post playing.

FIG. 16 shows the heat-map, which helps users to find the most active parts in a video.

FIG. 17 shows a user profile with the tags and vouches assigned to the user.

FIG. 18 shows a sample connection map of a Post.

FIG. 19 shows a smart solution finder feature.

FIG. 20 shows parameters used to suggest the best path to user for learning a subject.

### DETAILED DESCRIPTION OF THE INVENTION

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

### Definitions of Terms Used in the Description

Content Publisher: A content creation tool for creating content, including Post.

Post: A Post can be any content such as a tutorial, blog, documentation, article, feedback, event, document, link, or video. The platform uses the content publisher for creating Tutorial, Blog, Documentation, Feedback and Event Post types. Features available for each Post type are different.

Path: A Path or Learning Path is an ordered list of Posts. Each Post in a Path can also have sub posts as well.

Tag: A Tag in Programming.com platform is a topic or subject. Users can assign multiple Tags to a Post, User, Learning Path, etc. Tags can have children or parent Tags. The platform can also automatically assign Tags to different objects.

Foo: Foo is the measure of a user's knowledge and reputation in the Programming.com platform. Each user has a general Foo and a subject Foo. Subject Foo is the score given to user for a specific Tag. General Foo is weighted sum of all Subject Foo scores of the user. Users can increase their Foo by helping other users, posting content, receiving positive votes or anything, which shows the platform that they are knowledgeable about a Tag. The platform always normalizes users Subject and General Foo score to be a number between 0 and 100 where higher score means high knowledge and lower score means low knowledge.

Bar: Bar is the measure of reward in the Programming.com platform. Bar is the virtual reward currency used in Programming.com platform. Users can gain Bars by different activities like making tutorials, receiving positive votes, helping others to improve their tutorials, helping others by chatting, etc. Users can spend their Bars for promoting themselves, their projects, or getting help from other experts.

Pointer: Pointer is a device that is capable of pointing to or referencing a position on a display device.

Collaborative System Description

FIG. 1 shows a block diagram of a Software as a Service (SaaS) platform offering services embodying various aspects of the present invention. The SaaS platform comprises an Application/Web Server Cluster of one or more servers, which communicates with a Database Server Cluster of one or more databases. The SaaS platform can be used to provide collaboration services offered by multiple service providers. For example, a first and a second service provider can each offer independent educational collaboration services to individuals or participants in an institution or organization (e.g., university, research lab, crowd funding platform, school). The collaboration takes place over the Internet via a firewall Cluster of one or more firewalls. One collaboration SaaS can be implemented in the cloud to serve various industries such financial, multimedia, transport or logistics, etc. Virtual components, such as a contact center can be implemented for suitable applications.

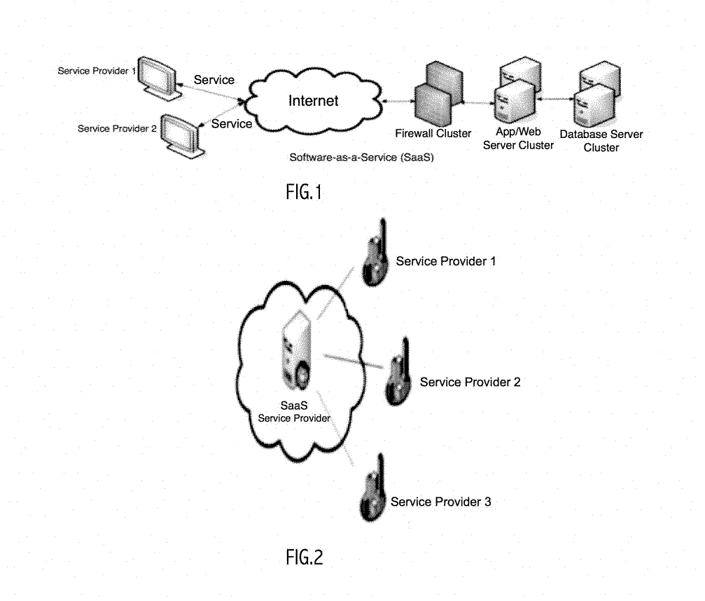

FIG. 2 shows the educational collaboration system of FIG. 1 implemented as a cloud service subscribed by three service providers. Under one arrangement, each service provider can be paired with another service provider within the SaaS for collaboration purposes. That is, Service Provider 1 can be paired with Service Provider 2 and Service Provider 2 can be paired with Service Provider 3, while Service Provider 1 is also paired with Service Provider 3. Under a premium subscription level, anyone of the service providers can deploy the educational collaboration service in-house as an enterprise solution for collaboration management, yet seamlessly communicates with the SaaS platform for exchange and collaboration with other collaboration service subscribers.

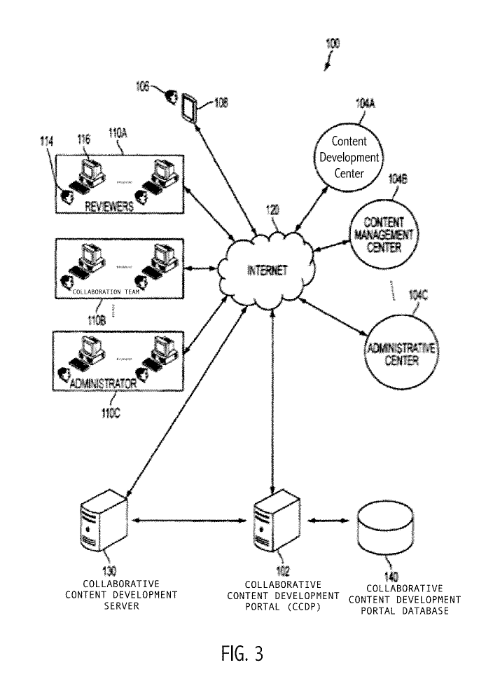

FIG. 3 depicts an exemplary block diagram of a collaborative content management system 100 according to an exemplary embodiment of the present invention. According to this embodiment, a content development center 104A, a content management center 104B and an administrative center 104C are connected to a collaborative content development portal (CCDP) 102 through a network, such as the internet 120. Also connected to the CCDP 102, which is part of the collaborative content development environment of the present invention, is a plurality of user nodes 108 or 116. Users of the system can be an individual collaboration participants 106, one or more collaboration reviewers 114 with workstations 116 within a review team 110A, or part of a collaboration team 110B of participants. Users can also be administrators and any other person that uses the system of FIG. 3. The user nodes 116 interface with users, such as collaboration participants via one or more participant device. Such participants can be students, teachers, instructors and experts and reviews. As shown, a reviewer device 110A is used by a collaboration reviewer. Workstations 110B are used by collaboration team participants and/or workstations 110C is used by an administrator.

Generally, a network comprises a plurality of privately or publicly connected nodes that are enabled to exchange information over one or more links. Exemplary networks comprise any one or more of WANs, LANs, PANs, internet 120 (as shown in FIG. 1) or Extranets. The Internet 120 is a collection of interconnected (public and/or private) networks that are linked together by a set of standard protocols to form a global, distributed network. A node comprises one or more processor units (software or hardware or both) and/or devices located anywhere in the network that processes information and/or performs an attributed function. Different types of nodes can include a receiver node, which received information, a processor node, which processes information, and a transmitter node, which transmits processed information. Examples of nodes include server nodes, client nodes, computer nodes, processor node, communication nodes, work stations, PDAs, mobile devices, forming any of content entry nodes, user interface nodes, accounting nodes, administration nodes, content delivery nodes, selection nodes, etc.

Accordingly, the collaboration system of the invention comprised one or more servers configured to interface with a plurality of user devices over a network. The plurality of user devices van be a first user device and one or more second user devices. The first user device and said one or more second user devices are user devices used by different users.

The nodes of the system can be connected to each other according to any suitable network model, including but not limited to client server models as well as a hierarchical or distribution models. A link comprises any medium over which two nodes may communicate information with each other. Exemplary links include, but are not limited to, wired, fiber, cable, or wireless links. A communication channel comprises any channel used with a link for delivery of content, which can include courses, learning or instructional materials, or environments amongst participants of the invention, weekly schedules, syllabi, assignments, resources, due dates, discussions, reflections, content summaries, content reviews, quizzes, tests, any other course material information, or any combination thereof.

According to the exemplary embodiment of FIG. 3, a user node can be a wireless node 108 used by an individual user 106 for connecting to the network. The users 106, 114 at the user nodes 108, 116 can be team participants, administrators, faculty, teachers, students, consultants, publishers, suppliers, content developers, etc. Alternatively, the user may be a responsible authority registered at the content development center 104A, the content management center 104B, or the administrative center 104C.

In one embodiment, the CCDP 102 provides a gateway between the user nodes 108, 116, the content development support centers 104A-C, and the collaborative content development system (CCDS) 130 through the network 120. The CCDS 130 executes suitable applications for providing one or more collaborative environments during which the team and reviewers can work collaboratively on developed content or to develop content. As further described later in details, such collaborative content development may take place over mass collaboration systems as well as social networking systems. In one exemplary embodiment, the CCDS 130 can be a stand alone system providing collaborative sessions to participants according to the present invention.

As is described later in more detail, the CCDS 130 provides the necessary user interfaces for the team participants, reviewers, administrators and other participants' to communicate with one another, for example, allowing collaboration content development participants to interact with and monitor reviewer participants activities. The CCDS 130 can also access one or more databases containing information relating to participants, content, and instructional material that is shared by participants during the content development process. The CCDS 130 also includes one or more databases containing reviewer comments and rankings, pre-defined satisfaction criteria and results of ranking comparisons as further described below.

The CCDP 102 provides an interface between the users, e.g. team, reviewers or any participant, and the CCDS 130. The CCDP 102 may also provide an interface for administrators to access the CCDS 130. The CCDP 102 is provided with a collaborative content portal database 140, which stores user information for all participants enrolled or associated with each content development process. The CCDP 102 provides means for participants to log onto the collaborative content development system 130 with a user ID and password. Based on the access privilege associated with the user ID, the CCDP 102 may authenticate the participant as a team participant, an administrator or a reviewer, a teacher, faculty, or student, etc. The CCDP 102 also tracks the team and reviewers' attendance and billing. Finally, the CCDP 102 synchronizes the information stored between the CCDS 130 and the support centers 104A-C.

Through the collaborative environment created by the system and method of the present invention, a team participant can assign instructional material to a reviewer enrolled in the content development process, monitor the reviewer's progress, and interface with the reviewer through interactive communication channels in real time or non-real time modes.

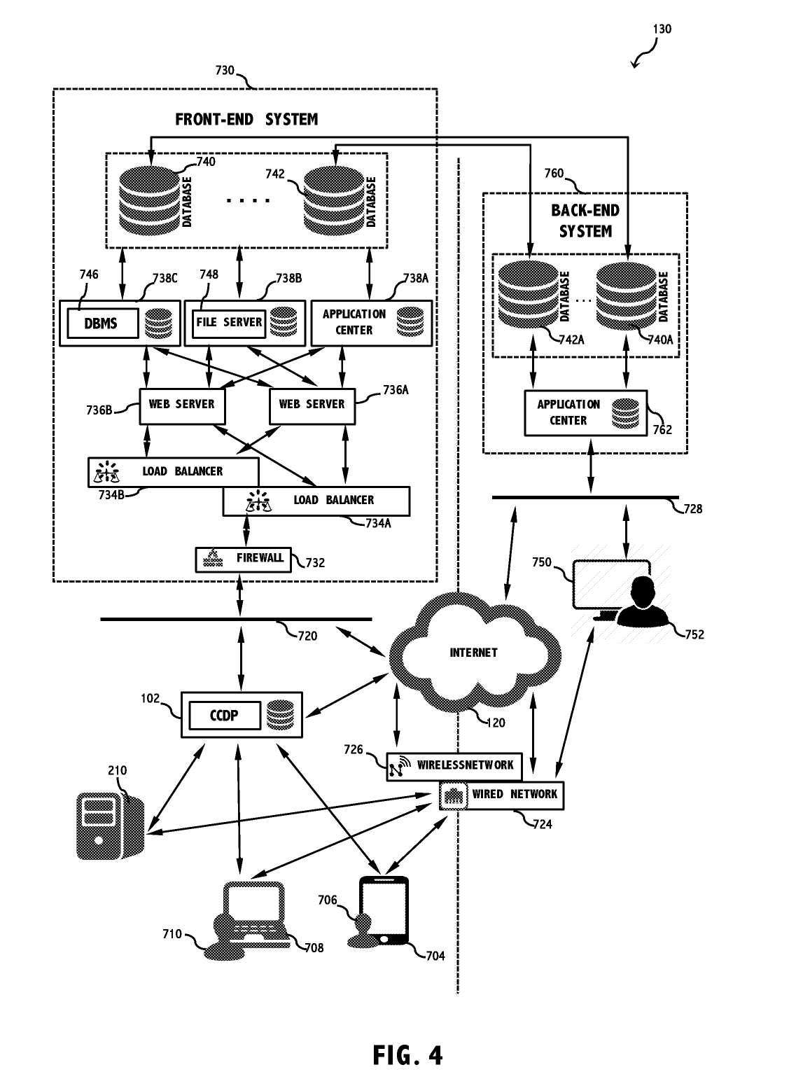

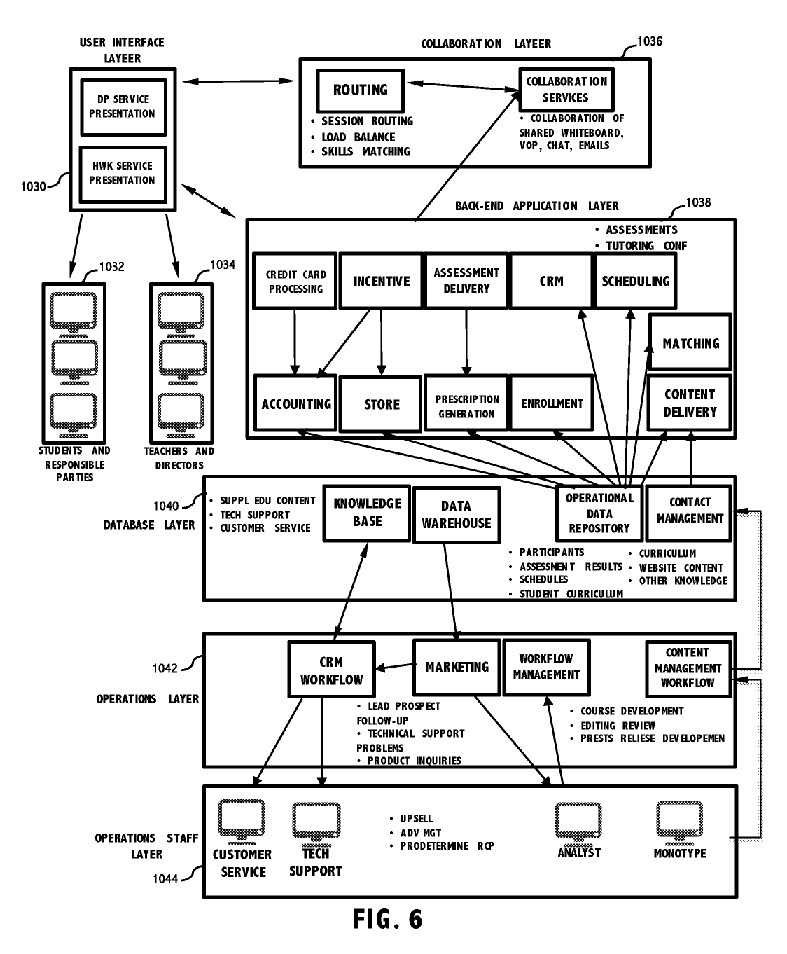

FIG. 4 shows the content development environment of the present invention implemented using a mass collaboration system and a social networking system as shown and described in connection with FIG. 6. FIG. 4 shows an exemplary block diagram of the online CCDS 130 according to an exemplary mass collaboration embodiment. Some of the functions of the online CCDS 130 include establishing online mass collaboration sessions, development and delivery of content. According to this embodiment, the CCDS 130 includes a front-end system 730 and a back-end system 760. The front-end system 730 provides user interfaces to participants for accessing the collaborative environment. The back-end system 760 is used for system administration, implementation in various environments, as well as application developments for billing, marketing, public relations, etc.

The front-end system 730 interfaces with the user devices 704, 708, allowing participants 706, 710 (e.g., team participants, reviewers and administrators, content developers, etc.) to interface with the collaborative environment according to the present invention. The front-end system 730 provides the participants interactive access to collaboration sessions. The user devices 704, 708 and/or the content development center server 210 are coupled to the CCDP 102 via a network 720, which may be LAN, WAN or other local network. Depending on design, the CCDP server 210 may also act as a gateway between the user devices 704, 708, and the content development center 104A (see FIG. 3), which manages the collaborative content development environment established according to the present invention. In this arrangement, the user devices 704, 708, and/or CDC server 210 may be coupled to the CCDP 102 via the Internet 120 or through a wired network 724 and/or a wireless network 726, for interface with the front-end and back-end systems 730 and 760.

In an exemplary embodiment, the user devices 704, 708 execute a network access application, for example, but not limited to a browser or any other suitable application or applet, for accessing the front-end system 730. The users 706, 710 may be required to go through a log-in session before engaging in an online collaborative environment through a suitable portal. Other arrangements that do not require a log-in session may also be provided in accordance with other exemplary embodiments of the invention.

In the exemplary embodiment shown in FIG. 4, the front-end system 730 includes a firewall 732, which is coupled to one or more load balancers 734A, 734B. Load balancers 734A-B are in turn coupled to one or more web servers 736A-B. For providing a collaborative environment according to the present invention, web servers 736A-B are coupled to one or more application servers 738A-C, each of which includes and/or accesses one or more databases 740, 742, which may be central or distributed databases. Web servers 736A-B, coupled with load balancers 734A-B, perform load balancing functions for providing optimum online session performance by transferring client user requests to one or more of the application servers 738A-C according to a series of course sketches and/or rules. The application servers 738A-C may include a database management system (DBMS) 746 and/or a file server 748, which manage access to one or more databases 740, 742. In the exemplary embodiment depicted in FIG. 4, the application server 738A and/or 738B provides content to the participants 706, 708, which includes electronic interfaces, content material, participant profiles, etc. Some of the content is generated via code stored either on the application servers 738A and/or 738B, while some other information and content is retrieved along with the necessary data from the databases 740, 742 via application server 738C. The application server 738B may also provide users 702, 706 access to executable files which can be downloaded and installed on user devices 704, 708 for creating an appropriate virtual content development environment, with branding and or marketing features that are tailored for a particular application, team participant or reviewer.

The central or distributed database 740, 742, stores, among other things, the content and other material deliverable to the participants. The database 740, 742 also stores retrievable information relating to or associated with by various types of participants, the team, reviewers, administrators, developers, the content development center, the content management center, the administrative center, reviewer profiles, billing information, schedules, statistical data, progress data, social network data, reviewer attributes, participant attributes, team participant attributes, mass collaboration data, ranking data, compliance data, certification data, billing rules, third party contract rules, government requirements, etc. Any or all of the foregoing data can be processed and associated as necessary for achieving a desired objective associated with operating the system of the present invention. For example, statistical data related to participant attendance, team member progress, schedules may process for matching two or more participants grouped into teams based on defined criteria.

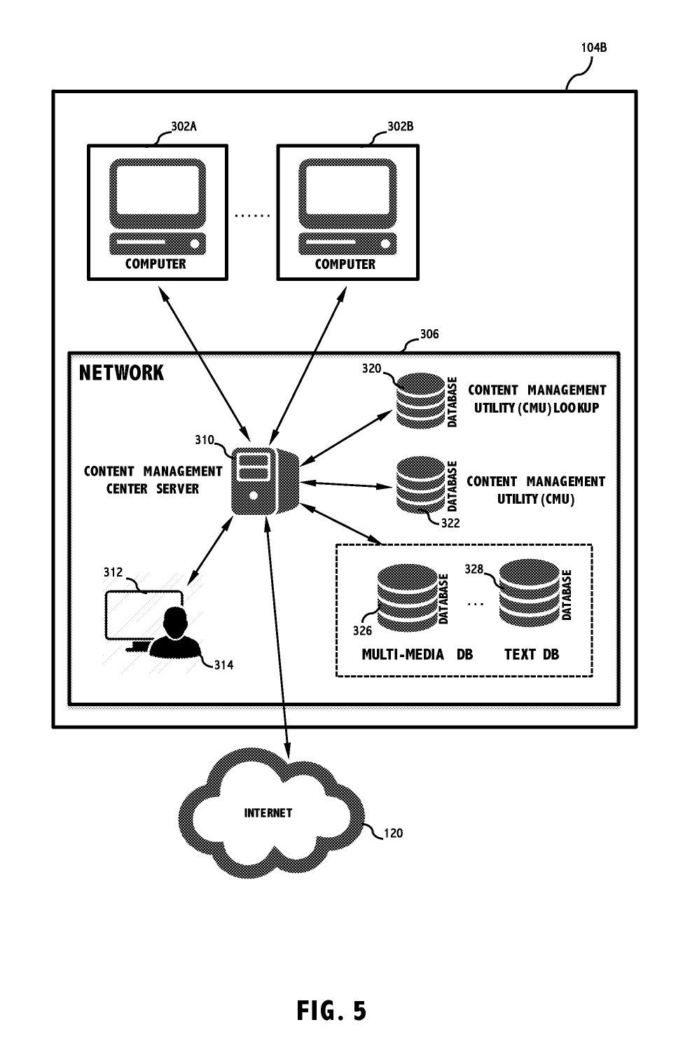

FIG. 5 depicts an exemplary block diagram of the content management center 104B in the content development system 100 of FIG. 3, which is managed and maintained by one or more administrators and accessible by those participants who are involved in the content development process, namely content developers. The content management center 104B includes one or more workstations 302A-B and a content management network 306 that is used by the team members and content developers. The content management network 306 includes a content management server 310 providing connectivity to the internet 120. The content management network 306 also includes a system administrator 314 who monitors and administers the local server 310 through a workstation 312.

The content management server 310 executes a content management utility that provides the platform for storing content, which can include multi-media and non multi-media content, examples of which are courses, weekly schedules, syllabi, assignments, resources, due dates, discussions, reflections, content summaries, content reviews, quizzes, tests, any other course material information, or any combination thereof, as well as delivering such content to users during collaboration according to the present invention between the team participants. The content management server 310 is coupled to a content management utility database 322 which stores content and content information, including copyrights, fees, delivery dates and cost adjustments.

During the collaboration sessions the content management utility retrieves from and/or stores in the content management utility database 322 content and related information for use in the collaboration process and based on team instructions, delivers specific content to users for comments and ranking. Additionally, the content management utility database 322 may store additional content recommended and uploaded by the content developers and reviewer during a content development process. The content management center is also coupled to a content management utility lookup database 320, which is used to store content information for cost projection, billing and lookup purposes.

In addition to the content management utility, the content management center server 310 is provided with a database utility providing one or more content databases 326 and 328. The content management utility uses the collaborative environment of the invention to process the reviewers' ranking and comments associated with each content item, which can be in any suitable form including video, images, audio, multi-media, text, etc. In an exemplary embodiment, the database 326 or 328 may store a multi-media course content item list.

Referring to FIG. 6, a block diagram of operation layers of the CCDS 130 is shown for creating a collaborative course development environment using a social networking service. The social network service offered by the system of FIG. 6 builds online communities of participants, e.g., participants, reviewers, experts, developers, faculty, teachers, student, content providers and any other participant in the collaborative content development environment and content delivery according to the present invention.

In one embodiment, the social network that is used for creating the collaborative content development environment of the present invention is web-based and provides a variety of ways for participants to interact, such as via e-mail, chat rooms or instant messaging. In this way, the participants can communicate and share information regarding contents according to the present invention. Examples of social networking paradigms that may be implement under the present invention, include Facebook, Myspace, Twitter, LinkedIn, Tagged, Diggs, etc. According to an exemplary embodiment, in the social network site, contributors may be gathered, organized and authenticated into the development process. Participants in the social network may include, for example, but not limited to, faculty, students, practitioners, consultants, publishers, suppliers, content developers, etc. who wish to contribute instructional content. Participants may register and input their credentials.

According to a further exemplary embodiment, a social site software module may be configured to organize participants in the collaboration process, enroll participants online, post required and voluntary personal and professional data of participants, define the connections of participants to one another, manage the selection of participants for development of a particular course or program, generate email lists of selected participants, and operate in multiple languages.

The CCDS shown in FIG. 6 includes reviewer workstations 1032 as well as core team and administrator workstations 1034. Each workstation can be a node connected to the CCDS 130 from any location. The workstations 1032 and 1034 execute suitable application programs, e.g., browser, etc., for engaging in review and ranking activities within the collaborative course development environment using a social networking service. The course development program running on a reviewer workstation 1032 enables a reviewer to interact with a core team member or other reviewers during a non-interactive or an interactive mass collaboration session over an implemented social networking service. Course development application programs allows a core team member to engage reviewers in multiple mass collaboration sessions.

Various application program layers for supporting the CCDS 130 in the social networking service may include a user interface layer 1030, collaboration layer 1036, a back-end application layer 1038, a database layer 1040, an operations layer 1042 and an operations staff layer 1044. Each layer, or any of its components, can run on any suitably configured node, including servers or workstations, anywhere in the system in a central or a distributed manner.

The user interface layer 1030 is responsible for interfacing with participants, reviewers and administrators amongst other users. The user interface layer 1030 receives input from multiple user devices or any other node associated with the system, including but not limited to processor, receiver, transmitter, or nodes associated with social networking services, third-party content development services, etc. The user devices, for example, workstations 1032 and 1034, are equipped with keyboards, mouse, pointers, display, pen-based tablets, audio headsets, speakers, cameras, media players, etc. In this way, the user interface layer 1030 can communicate texts, image, video and audio information with the nodes. Communication includes both the receipt and transmittal of information. In one embodiment, participants, reviewers and/or experts can attend collaboration or development sessions individually or as teams from any node as long as their respective access rights are verified via log-in processes within the social networking environment. For example, when a participant logs in, the system provides the necessary rights and privileges for accessing the collaboration system. The back-end application layer 1038 may also manage content delivery, reviewer and course development item matching, as well as mass collaboration scheduling and billing functions. The collaboration layer 1036 may provide social networking collaboration amongst the participants, e.g., the core team, reviewers, course developers. The collaboration layer 1036 provides collaboration tools such as chat functions that may be required in a collaborative course environment. As stated above, the collaboration layer 1036 is responsible for routing and collaborating services. The collaboration layer 1036 allows utilization of Voice Over Internet Protocols (VOID) standards in maintaining interactive channels for transmitting audio and video information. An interactive channel formed over links is used for holding an interactive session between participants, reviewers, experts, and other users. The interactive session allows the participants, experts, reviewers, and other users to interact with each other through collaboration tools such as chat functions. Other interactive mass collaboration tools for collaboration can include but are not limited to interactive highlighters, drawing and graphical tools, and etc. The collaboration layer 1036 also supports chat, e-mail, and other Internet features.

The database layer 1040 may manage information storage functions related to user and course or learning content environments, information and data, including textual documents, multi-media content, digital content and other knowledge base information. The database layer 1040 can also be a repository for operational data including the participants, schedules, ranking results and selected content items. Data warehousing functions and statistical analysis of reviewer ranking data against pre-defined satisfaction criteria may also be performed by the database layer 1040. The database layer 1040 may also manage the knowledge base comprising technical support, and customer service information.

The back-end layer 1038 may track various activities and inputs of participants, experts, reviewers, and other users and may record input data, either automatically through user devices 1032, 1034. The back-end application layer 1038 may also be responsible for delivering instructional content to the user interface layer 1030. The back-end application layer 1038 may also track deliveries of learning content materials to be implemented in the content development process of the invention for charge calculation and billing purposes. The back-end application layer 1038 may also perform credit card processing and billing functions, for example, on a session-by-session basis, time or other criteria, as further described below.

Once enrolled, participants, experts, and other users may be invited to participate in one or more collaborative course. Users invited to collaborate on a course may be scheduled in accordance with the user profiles as specified within the system. For example, a user with an expertise in geology may be scheduled for collaboration on a course on that subject matter. A scheduling node (located anywhere in the system) tracks and manages reviewer scheduling. A reviewer/content matching node runs a matching algorithm for matching reviewers and learning content items based on the reviewer's particular area of expertise for collaboration sessions.

The operations layer 1042 may provide content management workflow, including adding course content, editing and reviewing the developed course using the system and method of the present invention. The operation layer 1042 may also manage marketing and CRM (customer relationship management) workflow. This layer may also provide for lead/prospect follow-up functions, technical support problems, and product inquiries. The operations layer 1042 may interface with the operational staff layer 1044 that comprises personal tech support, customer service and analyst information. The operations layer 1042 also may provide for routing of information over the network for course collaboration sessions.

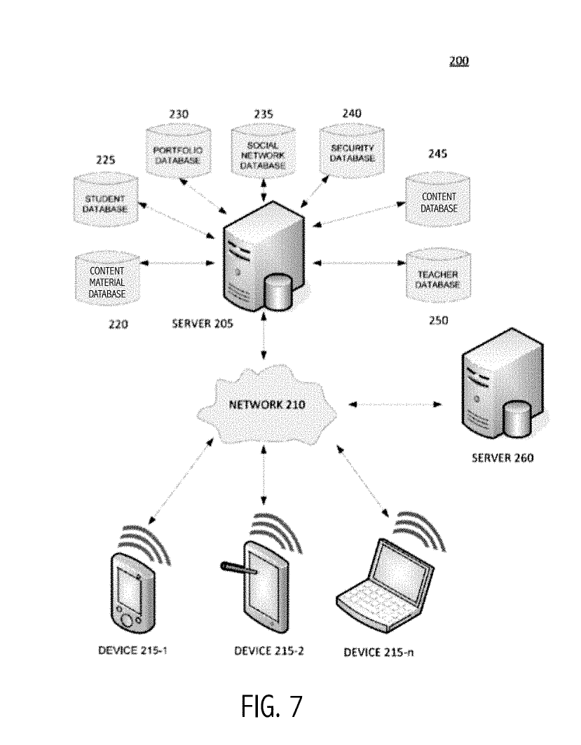

FIG. 7 depicts an exemplary educational collaboration system 200 in accordance with one or more embodiments. In one embodiment, users of devices 215-1 through 215-n may register within a particular learning system and may connect to a network 210 (e.g. the Internet). Each of devices 215-1 through 215-n may be a computer, workstation, mobile device, a PDA, an iPad, or a laptop computer. A server 205 may be maintained by the school/university/company or any third party vendor. Collaboration system 200 may also include a server 260. Server 260 may include any combination of features of server 205. Server 260 may also be connected to the other parts of collaboration system 200 through network 210. Server 260 may be located on the same network as server 205 or on a different network as server 205. Server 260 may run or operate other instances the software used to provide the online collaboration system. Server 260 may be run or operated by other institutions, either foreign or domestic. Server 260 may be run or operated by the same institution but in separate locations, either foreign or domestic. Education system 200 may include any number of additional servers, user devices, or network connections.

Server 205 may be connected to or include a number of databases, including a content material database 220, a student database 225, a portfolio database 230, a social network database 235, a security database 240, a content database 245, a teacher database 250, or any combination thereof. The content material database 220 may store any information about content materials. The content material database 220 may store, for any course, content, weekly schedules, syllabi, assignments, resources, due dates, discussions, reflections, content summaries, content reviews, quizzes, tests, any other course material information, or any combination thereof.

Student database 225 may store any information about students using the system. Student database 225 may store an inventory of all users that are affiliated with the particular learning program or institution or company. In one embodiment, such users are associated with network address, e.g., IP addresses, that may be stored in a user's profile. Student database 225 may store information about the students' names, student courses, locations, addresses, information about the student entered by the students, activities and interests of the students, education of the students, work experiences of the students, pictures of the users, or any combination thereof.

Portfolio database 230 may store information about users portfolios. user portfolios include information about users according to their role. For example, Portfolio database 230 may store information about courses the students have completed, activities the students have completed, examples of work products the students have completed, grades, evalutations, rankings, or any combination thereof.

Social network database 235 may store social networking information about the users of the system. Social networking information may include contacts of the users to which the users are connected, circles of the users, chat connections of the users, chat histories of the users, communities of the users, courses associated with the users, or any combination thereof. As used herein, a circle of a user means a set of other users associated with a user in the system. In one embodiment, a user's circles may be set by the user. As used herein, a community of the user may include any group or association of which the user is a part as identified by the system. Communities are different from contacts and circles because communities cannot be directly modified by users. Communities may be disbanded once a course ends, or past communities may be maintained. Social network database 235 may also store any other information related to the social networking information.

Security database 240 may store security information for the system. Security information may include usernames of the users, passwords of the users, security questions used for verifying the identity of the users, answers to security questions, which parts of the system the users are able to access, or any combination thereof.

Course database 245 may store any information about the courses offered by educational system 200. Course database 245 may store course names, course identifiers, course numbers, course descriptions, course teachers, course teaching assistants, course schedules, course enrollment including students enrolled in the courses, past course offerings, future course offerings, number of users allowed to enroll in a course, course structure, course prerequisites, or any combination thereof.

Teacher database 250 may store any information about the teachers, as well as authors of content using educational system 200. In one embodiment, teachers, as well as authors are associated with network address, e.g., IP addresses that may be stored in their respective user profile. Teacher database 250 may store information about the teachers or authors names, years teaching, programs involved with, locations, addresses, information about the teacher entered by the users, activities and interests of the teachers, education of the teachers, work experiences of the teachers, pictures of the teachers, or any combination thereof.

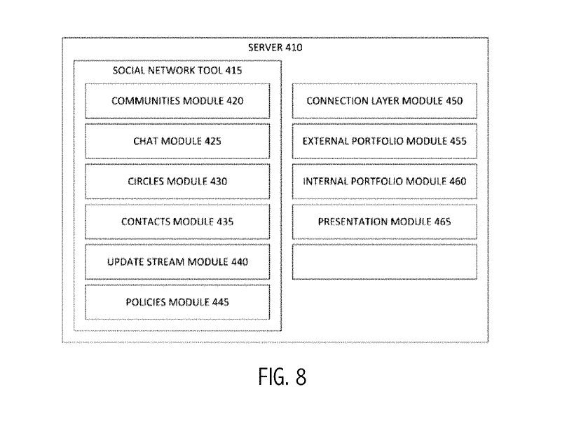

FIG. 8 shows physical topology of a site comprising computing servers, such as industry standard x86 servers that run under the control of one or more server operating systems, such as Windows, Linux, or VMware that create virtual or non-virtual environments. A number of similarly configured x86 servers can be grouped together with connections to the same network and storage subsystems to provide an aggregate set of resources. Enterprise storage, comprising Fiber Channel SAN arrays, iSCSI SAN arrays and NAS arrays, is used to meet different storage needs. Sharing the storage arrays between (by connecting them to) groups of servers via storage area networks allows aggregation of the storage resources. Server 410 may include a social network tool 415, a connection layer module 450, an external portfolio module 455, an internal portfolio module 460, a presentation module 465, or any combination thereof. Social network tool 415 may include a communities module 420, a chat module 425, a circles module 430, a contacts module 435, an update stream module 440, a policies module 445, or any combination thereof. The modules may provide the functionalities as further described below.

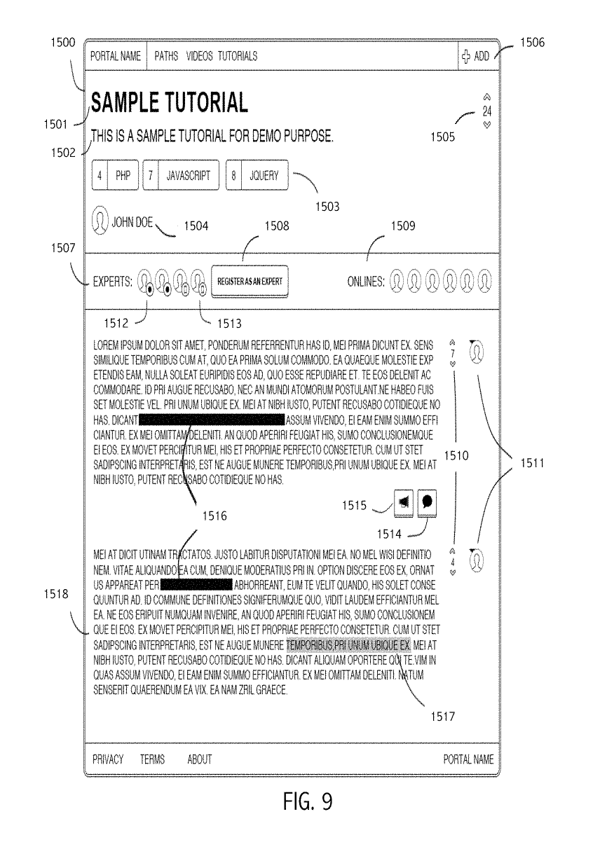

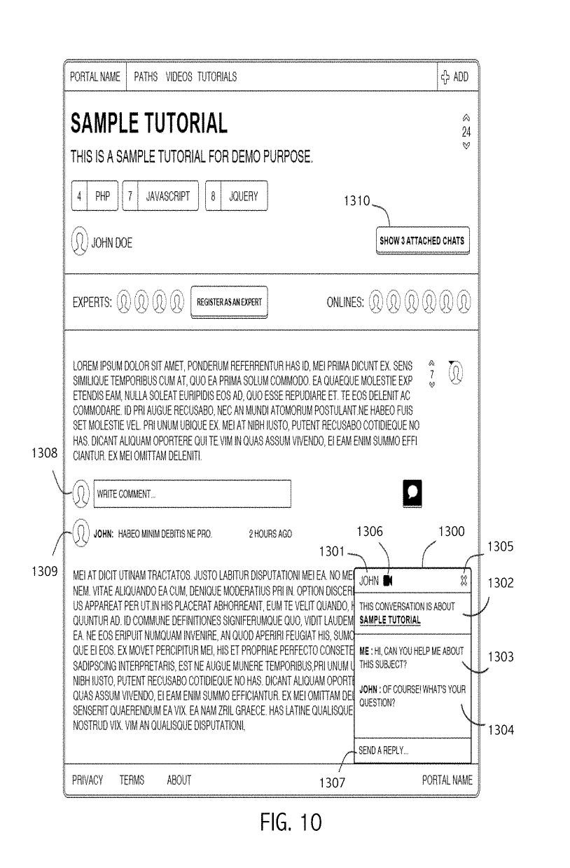

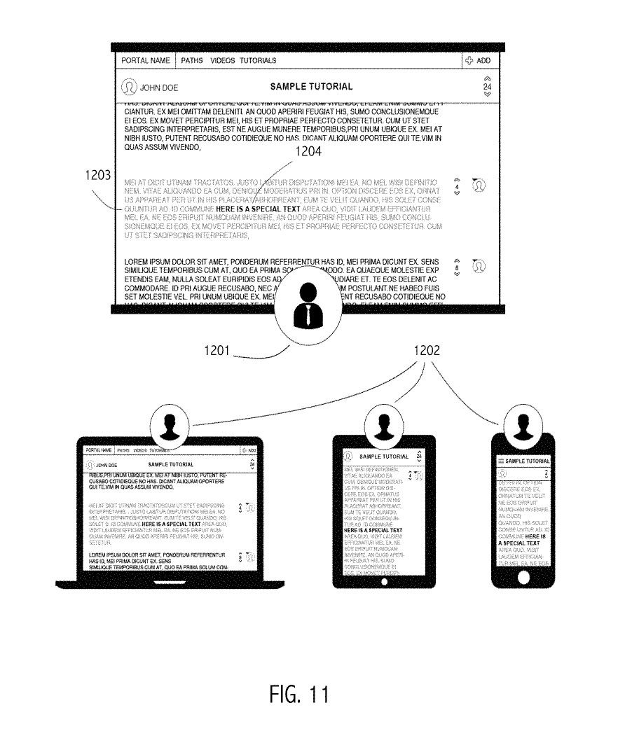

FIG. 9 shows an example of a front-end user interface of the collaboration system displaying a post. When viewing a post, a window on the display of the user device 1500 shows the title of the post 1501 as well as the tags associated with that post 1503. As shown in FIG. 9, the window on the display of the user device displays all online users reading the same Post 1509 as well as all expert users 1507 assigned to that post and whether or not they are online 1512 or offline 1513. Additionally, the collaboration system displays to all users reading a post, the paragraph that all other online users on the same post are most likely reading at any given time. For example, in FIG. 9, it can be seen that two users are reading different paragraphs 1511.

According to one aspect of the invention, a receiver node is configured to receive reading position information. The reading position information corresponds to a pointer position within a window on a display of a first user device. A processor node is configured to determine a second device of the one or more second user devices to receive a display message relating to the reading position information. A transmitter node configured to transmit the display message to the second user device or a plurality of user devices. This enables any user to collaborate more effectively with other users reading the same post by knowing the paragraph they are most likely reading at any given time. For example, if user one is reading a post and has a question regarding paragraph 1, knowing that user two is most likely reading the same paragraph, user one can contact user two and discuss the content. In one embodiment, the transmitter node can be configured to broadcast the display message to a plurality of second user devices. In another embodiment, the transmitter node is configured to check a privilege before transmitting said display message to a second user device.

The System uses an algorithm to approximate the paragraph or point in a Post each user is most probably reading. This algorithm uses different parameters to determine the reading position of users is in real-time. Such parameters include but are not limited to the following:
Real-time user pointer location
User's pointer patterns
Size of the window on the users display
Position of scrollbar on the window of the users display
Speed of scrolling the window of the users display
The direction of last scroll on the window of the users display
User's scrolling pattern history
Number and size of paragraphs in the window of the users display

Accordingly, the reading position information can be based on one or more of a current pointer location or a pointer movement pattern, size of the window, number of paragraphs within the window or size of a paragraph within the window.

In order to best approximate the most likely position that any user is reading in real-time, using JavaScript, the system first detects the best parameters for determining the reading position of a specific user according to their past or present behavior. In order to detect the best parameter, the system first removes areas in a post, which are outside a user's view, as users cannot read those parts. Once un-viewable areas of a post are removed, the system uses the following algorithm to approximate the most likely paragraph a user is reading within the window on the display of their device:
1. If user is moving a pointer horizontally on words in a line, the user is most likely reading the words underneath the pointer.
2. If a user is scrolling a window downwards and suddenly scrolls upwards, the user is most likely reading the first paragraph.
3. if a user is scrolling a window upwards and suddenly scrolls downwards, the user is most likely reading the last paragraph.
4. If a user is scrolling a window upwards or downwards fast but suddenly stops, the user is most likely reading the first paragraph.
5. If a user is not moving the pointer and scrolling a window downwards with an average scrolling speed, the user is most likely reading the area in top 20% of the height of the window.
6. If a user is not moving the pointer and scrolling a window upwards with an average scrolling speed, the user is most likely reading the area in the bottom 30% of the height of the window.
7. If a user does not move the pointer and does not scroll a window for more than 2 minutes the system marks the user as idle and shows the last most likely reading point with an idle mark.

Accordingly, the reading position information can be based one or more of a position of scrollbar, scrolling speed, scroll direction, or a scrolling pattern. The scrolling pattern can be based on a scrolling history. The reading position information can also be based a pointer movement on words in a line or on approximation of a likely viewing position on the display. The reading position information can for example be derived from zooming the window.

Once the processor node of the system approximates the reading position of a user, a transmitter node, broadcasts the reading position of that user to one or more user devices who are reading the same post and displays an icon or image of the user next to the reading position of the user on other users device.

The difference between sharing a user's reading Position and screen sharing is that a user's reading Position discloses where a user is most likely reading on a post on the window of their device and therefore there is no need for screen sharing or a need for a user to use a pointer to announce their reading position. Therefore, when a transmitter node transmits a user's reading position to other privileged users, the system does not transmit an image of the users display window, but instead transmits the reading position of the user. This is very useful when other users are using different devices with different resolutions. The difference between User's Viewing Position Approximation and systems like SoundCloud is that in SoundCloud users can comment on a second in an Audio and it will show where users commented to other users while a users viewing position discloses a user's media mark to other users. Under this arrangement, the system simulates students and teachers sitting around a round table and learning/teaching a subject together. The processor node can be configured to determine a display configuration for a second user device. Under this arrangement, the transmitter node is configured to transmit the display configuration to the second user device.

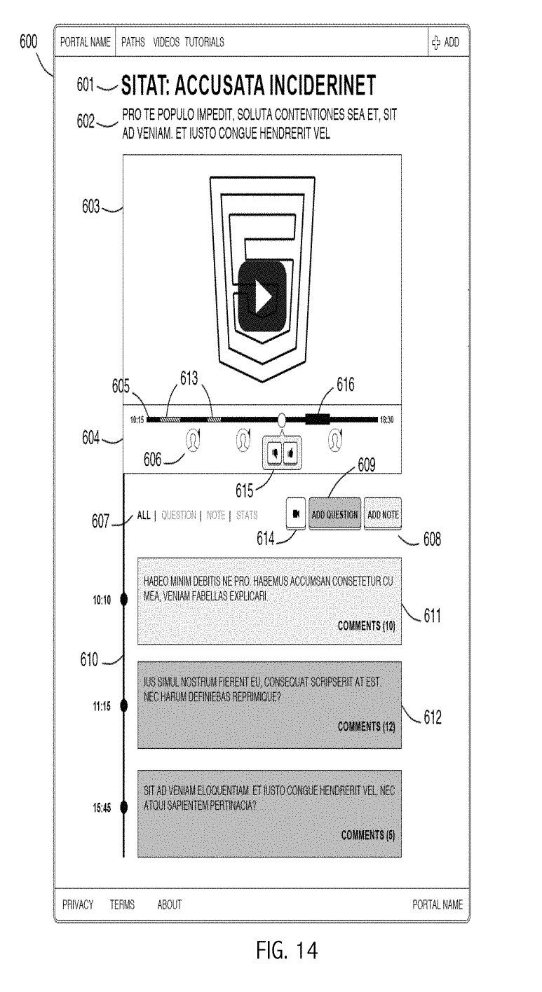

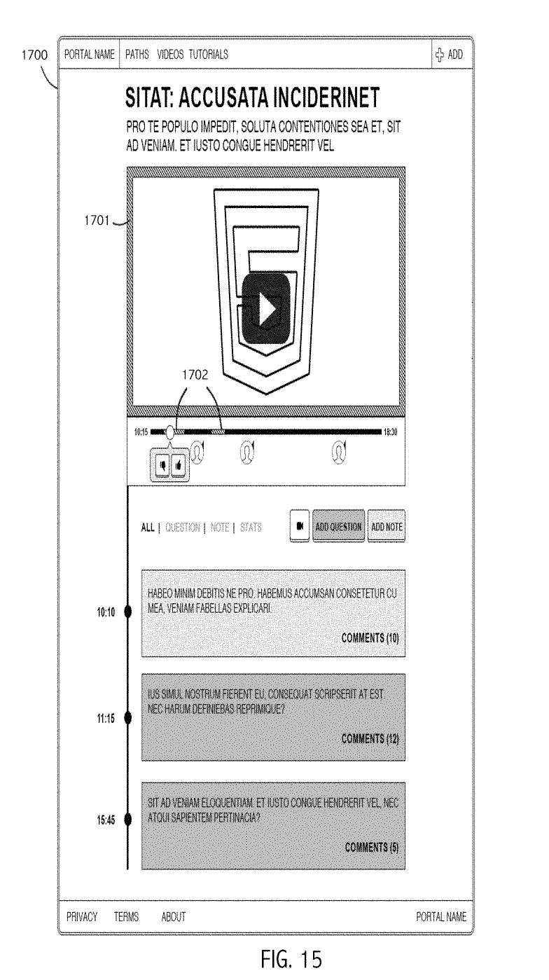

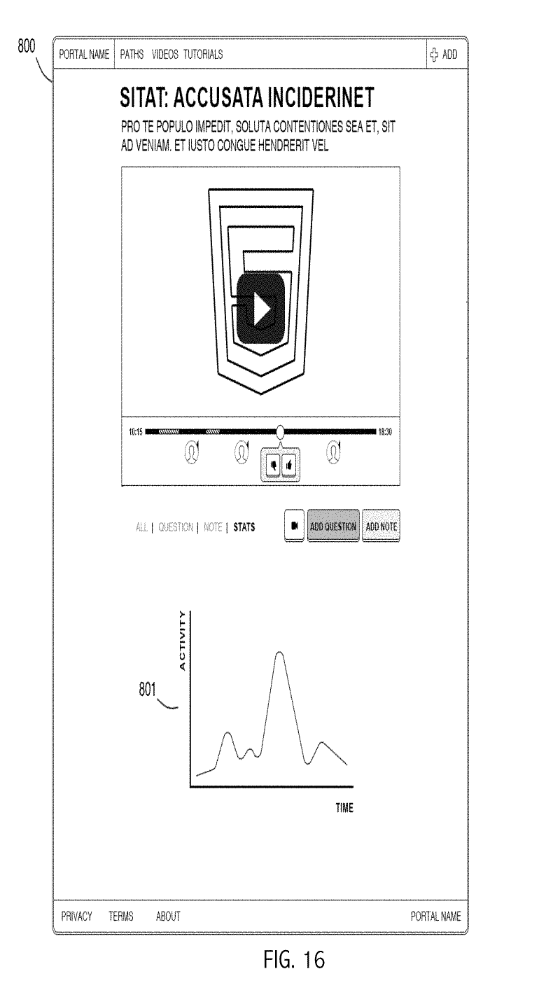

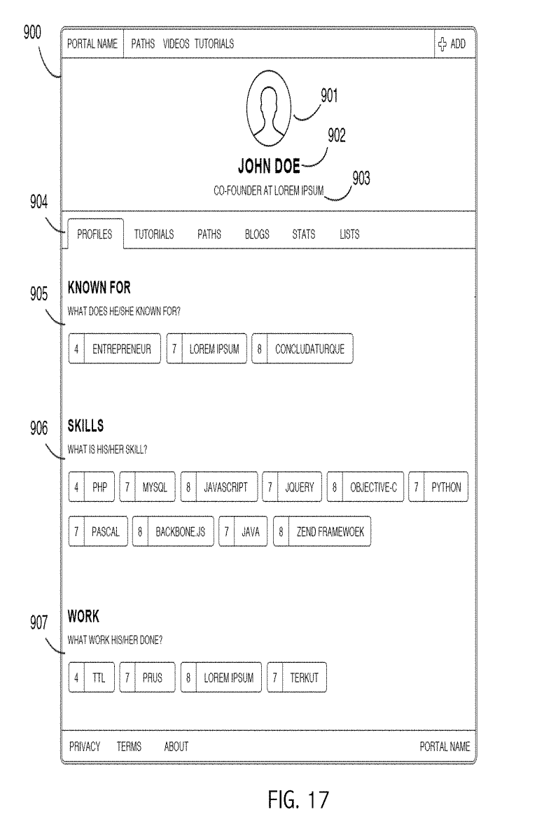

As shown in FIG. 14, when a user's window 600 shows a post, which contains audio or video content, a user can see all other users viewing or listening to the same post as well as the exact second of audio or video, which all other users in the same post are listening or watching 606 in real-time. A receiver node in the system is configured to receive media mark information from any users within a post containing a media player, which tells the system the exact second a user is playing on the media player at any given time. This information is then transferred to a processor node, which checks user privileges for determining all other users who can see the users position on the media player. A transmitter node then transmits the users media mark to all other users who are privileged to view this information. If a user pauses the media player and two minutes pass, the system marks them as idle and transmit that users media mark as the last second they were playing with an idle mark.

Under this arrangement, the receiver node is configured to receive a media mark information from a media play in the first user device. The media mark information comprises a reference to a position or time is the media at s first user device. The reference can be a time reference in an audio or video media or an image reference to a point in an image media. The processor node is configured to check user privileges for determining second user devices to receive a media message relating to the reference in the media at the first user device. The transmitter node is configured to transmit the media message to the second user device.

Other online collaborative tools such as the one used in Google docs allows one or more user to view or edit a file such as a word document simultaneously does not allow users to see each others pointer or reading position unless that user is editing the document. For example, if user one and user two are simultaneously viewing and editing a 5 page long word document on Google doc, user one cannot see where user two is reading and if user one wants to see where user two is making edits, user one would have to happens to be on the same page as user two to sees the changes happening real-time. Unlike the collaboration tool used in Google docs, this collaboration system allows users to know the reading position of all other users in the same post, who are given privileges in real-time.

### Screen Follow/Drag-Along/Co-Browsing

While users are chatting, each user can request screen locking, if other users accept the request, they will be following the presenter 301 who initiated the screen lock. When the presenter 301 scrolls up or down in a Post other users 302 will follow the scroll. Different users have different window sizes, our user view point algorithm calculates the most probable place which presenter is showing 303 and scrolls other users 302 exactly to that part. If the presenter goes to another Posts or pages in Programming.com platform, all other users will be following that. This is a great way of teaching a subject by showing the learners other related Posts.

According to yet another aspect of the invention, the receiver node is configured to receive a viewing position on a first display of a first user device. The viewing position is based on a pointed position within a window on the first display. The pointed position can be pointed to by a mouse or any kind of pointing device, for example on a post to drag along or co-browse with other users. The processor node configured to determine at least one of the one or more second user devices to receive a display command to follow the viewing position. The transmitter is configured to transmit the display command to a second user device. In one embodiment, the receiver node is configured to receive a screen lock request from the first user device and a response to the screen lock request from the second mobile, and wherein the processor node is configured to check user privileges the response to the screen lock request from the second mobile for determining one of the one or more second user devices to receive the display command relating to the viewing position.

The difference between scroll locking and regular screen sharing is that in screen sharing other users will see a snapshot of presenter's screen, so if the presenter is presenting in high resolution and other users are in lower resolution, they will be seeing a resized version of presenter's screen which causes smaller text on lower resolution devices such as phones. In screen locking we follow the position of presenter in the Post and will broadcast that position to other users, then the platform will focus other users 302 on that position. This way each user will see the Post will be shown in the best way for each device and focuses on the exact position where the presenter is showing. Users don't need to zoom in or out because the Post is responsively fit based on their device.

While screen is locked, if the presenter 301 goes to a Video Post, the platform will broadcast the second which the presenter is viewing and other users will be see exactly that second of the video. Again the platform detects best quality based on each user's device and network speed.

### Live Expert

Finding an expert or on a broad subject like PHP programming language might not be difficult, but, finding an expert or tutor on a special subject like Natural Language Processing in PHP is a very hard task. In Programming.com platform, platform users with a certain minimum score can become experts or tutors on different Posts. In each Post the platform shows verified experts about that Post 1507. An expert should have a minimum score on tags used in that Post to be able to register as a verified expert by clicking on “Register as an expert” button 1508. Also, if an expert's Foo score on any of the tags assigned to the post is more than a specific number like 95 out of 100, the platform will automatically register the user as an expert. Other users may vote if an expert is helpful or rate his/her performance on that special subject. If the expert cannot get enough votes or rate in a defined period of time he/she will be removed from the experts list of that Post.

Users who have questions or need help can easily contact experts by clicking on their name in the experts' list 1507. If said expert is online on the site 1512, or is using Programming.com platform native phone app 1513, or Programming.com platform extension, the message will be instantly delivered to the expert. Otherwise it will be added to their offline message box and they will get email notification. Experts can define a price for helping others on a Post. Other users can pay by Bars to get help from these experts. This embodiment will help users to find experts on specific content.

### Teaching Based Certificates

Under current educational systems, a user or student obtains certificate or diploma from an educational institution by taking required courses and pass those course's exams. Passing an exam doesn't mean students have fully learned subject matters covered by the course, and it only means that a student responded correctly to a required minimum of questions. In Programming.com platform, measure of a user's knowledge of a subject matter is determined based on the user's ability to teach that subject matter to others. If the user cannot simply explain a subject matter, it means that the user has not learned said subject matter. If a person wants to pass a course, he/she needs to teach different subject matters to other learners within a specific amount of time to gain enough points to pass a course. This way the questions the person answers are real life questions from other learners, and if that person can help others with that subject, it means he really learned it the well.

### Social Assessment

In Programming.com platform communication happens among users, for example when an expert answers another user's questions, via text chat 1300, video conference, or in-paragraph comment. In an embodiment, the system will ask both users for feedback and based on the feedback received, the expert will earn Foo and Bar and the user will earn Bar. With unanimous permission from all participants in a communication, users can share their communication with others or make the communication public. After giving permission to share a communication, users have the option to remove their name from the communication and share it as an anonymous user. In an embodiment, other users can see how well an expert helped users and based on that they can vote up or down a conversation or message. The platform will give Foo and Bar based on other users votes. Under this platform, users knowledge is being assessed based on user's opinion instead of exams.

### Smart Solution Finder

One way to earn Foo and Bar in Programming.com platform is smart solution finder. Platform users can pick specific tags in which they are expert. Platform will show them related questions 1101 which other users have asked. The user can swipe the question to right 1103, left 1102 or down 1104. If he knows the answer he can swipe the question to right 1103 and start answering. If user doesn't know the answer to the question he can swipe it to left 1102. By swiping down 1104 user can forward the question to an expert he thinks is the right person to answer this question. Users have the option to ask, forward or answer questions anonymously, this way other users will not see Name, Username or any identity of the specific user but they can contact the user using the anonymous one-way hash generated for the user by the platform.

### Smart Chat

Programming.com platform has redesigned chat from scratch to fit social teaching and learning better. Programming.com platform's chat includes, but no limited to, the following feature:

### Content-Specific Communication

In an embodiment a user can initiate a content-specific communication with one or more users or experts about a Post or Path. A user may initiate a content specific communication with one or more users or experts, by opening the chat box 1300. Each chat box includes header with the other one or more users or experts' names 1301, related Post or Path name 1302, and chat messages 1303 are listed in the in the conversation area 1304. A user can have multiple content-specific communications with other one or more users or experts about multiple Posts or Paths. This means we can have a content-specific communication per Post or Path for each user or group of users in oppose to regular chat systems which have one chat conversation per each user or group of users. This will help users to find content-specific communications about a specific Post, Path or Subject easier.

### Paragraph Mentioning

In an embodiment, in Programming.com platform, a user may select Paragraph Mentioning button and pick a paragraph or any content and share it with one or more other users or experts using Paragraph Mentioning syntaxes. A user may select a communication and click on Paragraph mentioning button and pick any content, like a paragraph in a Post, or a word in that paragraph, and the platform will insert and associate a specific link pointing to that paragraph, word, or content. When one or more other users select that link, said one or more other users will be taken to that paragraph/word immediately. Said one or more other users' previous display can be retrieved easily to return to previously using item or content.

### Chat Sharing

In an embodiment, after completion of a communication among one or more users or experts, system asks participants in said communication whether questions-presented or problems were resolved, and which tags to associate said problems with. If said problems are marked as resolved, the system will give points to said experts, tutors, or teachers, then system ask user's permission for sharing the conversation. Upon all users unanimously permission to share the communication, said communication will be attached to said Post. Said communication will be searchable and users can find the original post even if they search for contents which were mentioned in the attached communication.

Said one or more users or experts granting permission to share said communication may also request to hide their identity and reveal the communication anonymously, this way the platform will still share their communications but will change their name and identity with an anonymous one-way hash. If one or more other users or experts have questions from said anonymous user, they may contact said anonymous one or more users or experts using said hash. Said one or more users or experts may also choose to be not-contactable. Said non-contactability feature changes said hashes shown in said shared communication to fully anonymous user names.

### Micro-Voting

In an embodiment, one or more users or experts may vote up and down a paragraph in a Post using Micro-voting buttons 1510. Micro-voting helps content publishers review paragraphs that are well written, not helpful, or unlikeable by platform users. In an embodiment, one or more other users can improve said Post by editing those paragraphs or suggest changes. All Posts, including original publisher's post, and changed by one or more other users are marked, so the original publisher can revert said post back to previous versions.

In an embodiment, users or publishers can see a highlighted version of a Post 1400, within which, paragraphs are color coded to red 1401 or green 1402 based on the number of votes, up or down, said paragraphs receive from users. This embodiment provides paragraph feedback to users.

### Learning Paths

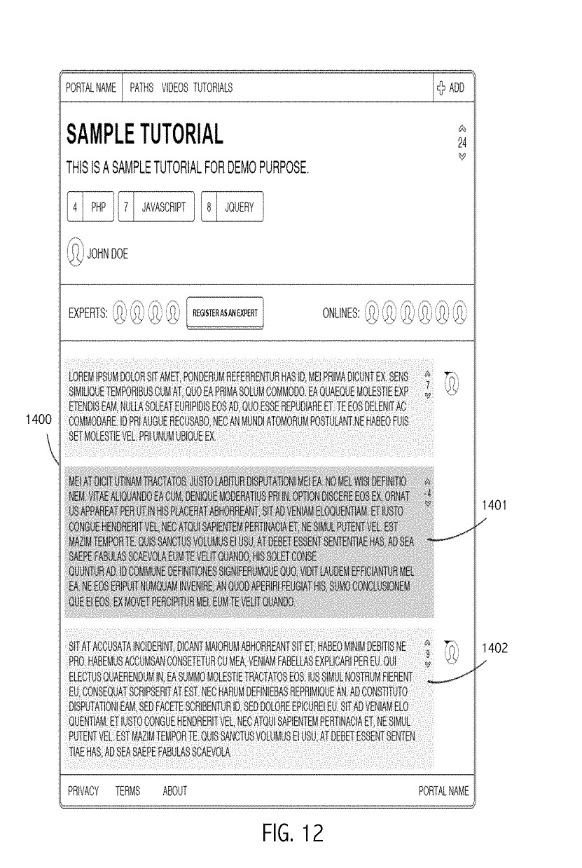

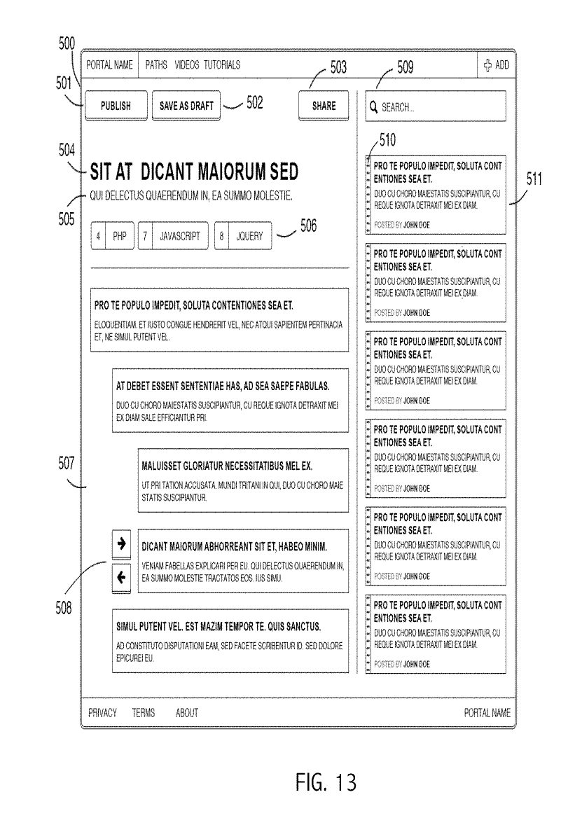

In an embodiment, Programming.com platform users can create different learning paths based on user's learning needs, using Path builder 500. Users with different ages, genders, locations, and backgrounds learn a very same thing differently. A learning path comprises of a number of ordered series of Posts. Platform suggests the best paths for any user based considering different factors, (FIG. 12), including, but not limited to the following:
User's previous browsing behavior
User's reading speed
User's age, location, gender
User's current Expertise
User's connections suggestions
Votes of tags for tutorials inside paths
User's ratings and feedback
User's reputation score
Optional tests available to user to take

This platform, for example, generates a different learning path suggestion to a 16-year-old boy from the US who knows JavaScript and wants to learn query, than a 30-year-old woman from Japan who started programming recently. In an embodiment, one or more users can filter learning paths based on reading-time. Programming.com platform incorporates an algorithm to calculate each user's reading speed, in comparison to average reading speed. Said one or more users can filter learning paths shown to only said paths which require a maximum number of hours like 15 hours or less.

### Content Reusing

In an embodiment, a user teaching one or more subject, may use at least a portion of Posts or Paths taught by one or more other users or experts, as at least a part of their teaching material A user may combine other one or more user's Posts to complete their pedagogical objectives.

### Path Builder

In an embodiment withinProgramming.com platform, one or more users may create a number of new ordered series of Posts, new Paths, using Path Builder. One or more users can search for Posts in the Posts list 511 using the search tool 509. After finding desired Posts, one or more users can add said Post to said Path by dragging said Post to Path main area 507 using Post drag handle 510 or double clicking on said Posts. One or more users can reorder Posts in Path main area 507 by dragging them up or down and also indent posts using indent buttons 508. By using said indent buttons, one or more users can define children Posts. Said one or more users can set Title 504 and Summary 505 as well as assigning Tags 506 to said Paths. Said Paths may also be published to the public platform using Publish button 501 or saved as draft 502. The author can share the Path with other users using Share button 503. This gives the author the ability to get help from other authors to make a better learning Path. While sharing the Path the author can give different permissions to each user including read, read and update and reordering.

### Video Post

A Video Post 600 contains a main video 603 on top, and a timeline under the video 610.

One or more users can see which second of a video post one or more other users are currently watching 606 under video's seek bar 605. Users can chat about a video post, by adding notes or asking questions under the video post using Add Question 609 and Add Note 608 buttons, and this content attaches to the time that the video content was broadcasted. Each of the posted content are reach-content because they are basically a post, and they can include code, other videos, audio, tweet or any kind of embed supported service. Users can also instantly send a video response using phone or webcam by clicking on video response button 614. Currently, comments or posts cannot be posted on a video post online, like Youtube videos, and also, videos are only searchable based on their title, description and tags. In Programming.com platform, a user can copy a video link and add notes to specific time periods in a video. For instance, a user can add a code as a note, or if there is another video which describes a part of the first video in more details, the user can add the descriptive video to a corresponding time of the original video. Also files, images or regular text can be attached to a certain time in a video. When user plays a video, timeline 610 under it automatically scrolls based on the time of the video, so related content corresponding to a specific time of a video is shown to the viewing user. Users can also vote up or down to a certain moment or time in a video using time-voting buttons 615. Abovementioned features embodied in the platform are providing solution to several complications:

First, notes and contents attached to videos are searchable, and if users search for something and the platform find it in questions or notes, the platform will show that video as a result and when user clicks on it, it'll start playing the video from exactly where that keyword was stated for the video.

Second, if a user wants to go directly to a specific part of a video, user can browse corresponding notes quickly. By clicking on a dot set next to a note, a user will be taken to the exact corresponding video time to watch. This, reduces user waste-time substantially.

Third, In an embodiment, Programming.com platform make a heat-map 801 for a video which shows which parts of the video has more notes, questions, comments or votes on the timeline. When a user browses a Video Post, by quickly looking at the heat-map 801, user can figure out which part of a Video Post has a better chance of containing useful information as it is more discussed or has a higher number of up votes.

### Talent Finding Based on Teaching

Currently, recruiters use recruiting websites to find right matches for right tasks or jobs. Most of recruiting websites, rate their users solely based on what they say about themselves or vouches received from other platform users. Both of these measurements are subjective and susceptible. In an embodiment, Programming.com platform, the platform gives a specific score to users based on their performance helping other users on specific matters or projects using their skills. As these scores and the criteria and reasons for giving a specific score are public recruiter can easily find contributions, which a user have made.

### Calculating Foo and Bar

The following table shows an example of a pointing criteria with which the Programming platform increases or decreases users Bars and Foos. A Foo is a number more than 0 and does not have an upper bound. Users may also earn a Subject Foo for Tags assigned to a Post, Path or User. If a Post has N tags, user will get 1/N solute Subject Foos for each Tag. At the end of each day the Platform calculates each user's Foos and Subject Foos by normalizing Foos and Subject Foos, so they will be between 0 and 100.

| Action | Foo | Bar |
|---|---|---|
| Importing a Post from another source | 0 | +3 |
| Writing a new Post | +8 | +5 |
| User’s Post gets a positive vote | +3 | +2 |
| User’s Post gets a negative vote | −2 | −1 |
| Answering a question on a Post | +3 | +3 |
| User’s article gets published | +8 | +5 |
| User’s article gets verified | +12 | +8 |
| User’s article gets spammed | −7 | −5 |
| Chatting about a Post as an expert, per message | +0.1 | +0.5 |
| Chatting about a Post as a learner, per message | 0 | +0.5 |
| Getting positive vote for a chat attached to a Post | +3 | +3 |
| Registering as a verified expert in a Post | +3 | +5 |
| Sharing a Post in social networks | 0 | +2 |
| Adding a note on a user’s Post | 0 | +0.5 |
| Someone adds a user’s Post to their learning list | +2 | +1 |
| User creates a Path | +10 | +5 |
| User’s Path gets a positive vote | +4 | +3 |
| User’s Path gets a negative vote | −3 | −2 |
| Start learning a Path | 0 | +5 |
| Getting a new learner in your Path | +5 | +10 |
| Suggesting a tag for a user | 0 | +0.5 |

### Connection Map

Within each user profile, the system tags each user based on the users Skills, Projects, Education, Location, Work history, and their reputation. Every post shows all online users who are reading that post including experts, participants, and other online users of that Post. From every Post's network map, users can view a graph of all other users, who are related to them with a description of how they are connected to each other based on their skills, projects, education, location, work and other tags. This allows users to have a better understanding of all other users of the same Post and therefore know who to contact for questions or for collaboration.

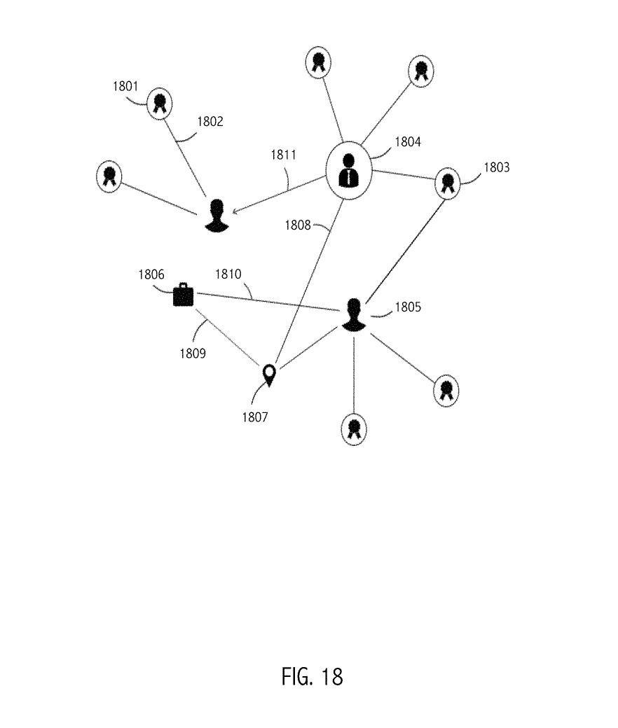

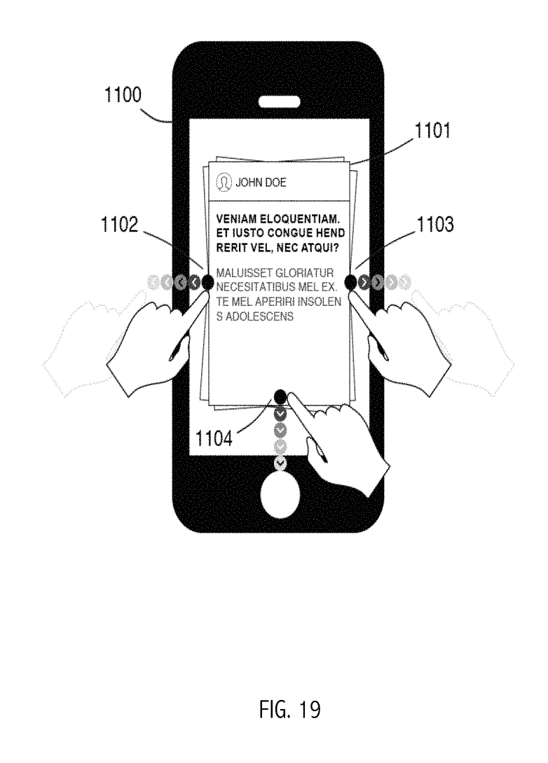

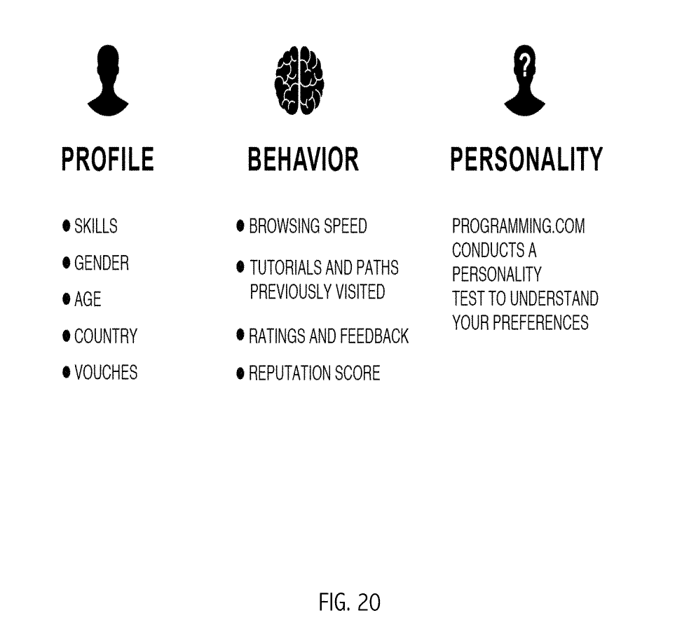

A connection map is shown in FIG. 18, where it can be seen that user 1804 is the user who has logged in, other users on the same post 1805, other users skills 1801, companies as users 1806, users locations 1807 and how they are connected. For example, in FIG. 18 user 1804 can see that there is a common location and a common skill with user 1805.

### Role Based Content Redaction and Highlighting

The system allows for users to redact 1516 or highlight 1517 portions of a Post for different users with different roles. A role is group of users with the same level of privilege. For instance, a researcher may have published content of a previous paper as a Post, however, might not want everybody to see certain names or paragraphs in the research paper. This system allows them to easily select those parts, redact them, and assign the redactions to a set of users based on their role. This way, when users who have been assigned to redactions based on their role read the Post, they won't be able to see content of that Post which has been marked for redaction. Additionally, users have the ability to highlight portions of a Post for users with different roles. Highlighting means they a background color will appear behind the selected content of a post. Assigning certain user roles to different highlighting portions of a Post, will allow different types of users to focus on different portions of a post.

This feature is also available on the system for Posts with media players. Users can select portions of a video or audio file for redaction or highlighting 616, 613. As shown in FIG. 14, when portions of a video are highlighted by a user, the users who are assigned to that highlighting will see the border of the video become highlighted based on the selected color for portion that it has been highlighted 1701. Additionally, the timeline of the video player shows the highlighted portions of the video to users assigned to the highlighting based on their privileges 1702.

### Smart Tracking and Triggers

In an embodiment, within Programming.com platform, when a user begins reading a Post, the platform constantly guesses which paragraph or word a user is reading based on User's Position Approximation. All these information are constantly sent to platform's logging servers via web sockets and are stored in a database. User's interactions with Learning Paths are also stored in the database. These information give the platform the ability to re-track User's behavior. Post or Path authors can re-track one or more other user's behavior on authors' Post or Path to see which parts needs to get improved. The platform also shows a heatmap of the Post to the author, which color codes each paragraph based on the time users spent on that paragraph as well as number of users who read that paragraph. This feature is also available for Paths. The platform can show a heatmap of Posts in a certain Path which color codes each Post in the Path based on the average time users spent on each Post and number of users who finished reading those Posts. Other than authors of Posts and Paths, users with certain permissions may access the re-track feature

### Smart Triggers

In an embodiment, an author of a Post or Path, may use smart tracking technology to define specific actions based on user's behavior on each of their Posts or Paths. For instance, authors of a Post can define a trigger to show extra information or a pop up with a video or text to a user when the user stops more than a certain time on a paragraph or certain section. Also authors of a Path can show extra information if a user spends more than a specific amount of time on a Post. This will help authors to guide their content's users if they get stuck in a section. Post or Path authors and users with certain permissions can define multiple triggers or combine multiple triggers using AND or OR logics and also, they can define multiple actions for one trigger.

The triggers which authors or users with certain permissions can define include the following:
When a user starts reading a paragraph or section in a Post.
When a user stops on a paragraph or section in a Post or Paragraph for more than specific time.
When a user returns to a paragraph in a Post more than a number of times.
When a user reads all paragraphs in a Post.
When a user reads all paragraphs in a Post faster than a specific time.
When a user reads all paragraphs in a Post slower than a specific time.
When a user starts reading a Post in a Path.
When a user stops on a Post in a Path for more than a specific time.
When a user reads a Post in a Path more than a number of times.
When a user finishes all Posts of a Path.
When a user finishes all Posts of a Path in less than a specific time.
When a user finishes all Posts of a Path more than a specific time.

The actions which authors or users with certain permissions can define include the following:
Show a user a text in a notification box.
Show a user a pop-up text or video.
Initiate text chat with a user.
Initiate video conference with a user.
Send an email to user, authors or preset Email addresses.
Send phone push notification to Users, Authors or preset Users.
Introduce an expert to a user.
Send browser notification to Users, Authors or preset Users.
Block a user from doing anything on the platform with a custom message.

From the foregoing description, it should be appreciated that the present invention creates a collaborative environment that allows for efficient and intelligent interface for individual or team participants to share, review, rank, chat and create content.

1. A collaboration system, comprising:
one or more servers configured to interface with a plurality of user devices over a network, wherein said plurality of user devices comprise a first user device and one or more second user devices, said first user device and said one or more second user devices being user devices used by different users;
a receiver node configured to receive a reading position information, said reading position information corresponding to a pointer position within a window on a display of the first user device;
a processor node configured to determine a second device of the one or more second user devices to receive a display message relating to said reading position information; and
a transmitter node configured to transmit said display message to said one or more second user devices, wherein said reading position information is based on at least one of a current pointer location or a pointer movement pattern and wherein said reading position information is based on at least one of size of the window, number of paragraphs within the window or size of a paragraph within the window.

2. The system of claim 1, wherein said transmitter node is configured to broadcast said display message to a plurality of second user devices.

3. The system of claim 1, wherein said node is configured to check a privilege before transmitting said display message to a second user device.

4. The system of claim 1, wherein said reading position information is based on at least one of a position of scrollbar, scrolling speed, scroll direction, or a scrolling pattern.

5. The system of claim 6, wherein the scrolling pattern is based on a scrolling history.

6. The system of claim 1, wherein said reading position information is based on at least one of a pointer movement on words in a line.

7. The system of claim 1, wherein said reading position information is based on approximation of a likely viewing position on the display.

8. The system of claim 1, wherein said reading position information is derived from zooming the window.

9. The system of claim 1, wherein said processor node is configured to determine a display configuration for a second user device; and wherein said transmitter node is configured to transmit said display configuration to said second user device.

10. The system of claim 1, wherein the receiver node is configured to receive a viewing position on a first display of the first user device; said viewing position being based on a pointed position within a window on the first display; and wherein the processor node is configured to determine at least one of the one or more second user devices to receive a display command to follow the viewing position; and wherein the transmitter node is configured to transmit said display command to a second user device.
